(19) United States
(12) Patent Application Publication
(10) Pub. No.: US 2004/0186187 A1
(43) Pub. Date: Sep. 23, 2004

(54) Interconnected bubbles solution

(76) Inventor: Daniel M. Ammon, (US)

Correspondence Address: Kevin D. McCarthy, Roach Brown McCarthy & Gruber, P.C., 1620 Liberty Building, 420 Main Street, Buffalo, NY, 14202, US

(21) Appl. No.: 10/392,037

(22) Filed: Mar. 19, 2003

(51) Int. Cl. B01F 17/00

(52) U.S. Cl. 516/10

(57) ABSTRACT

The present invention is directed to a product and a method of making that product. The product is a unique bubble making solution that when bubbles are formed each bubble is interconnected to another bubble by a string of bubble solution. Admittedly, a portion of the bubble solution is known to those of ordinary skill in the art. That known portion is referred to as the fundamental bubble solution and it comprises at least one surfactant, at least one plasticizer, and water. From that fundamental bubble solution, the inventors add an effective amount of an organic polymeric resin having a molecular weight greater than 3 million. With that high molecular weight polymer, each formed bubble is interconnected to another bubble.

### FIELD OF THE INVENTION

The present invention is directed to bubble formulations.

### BACKGROUND OF THE INVENTION

Bubbles have been manufactured for many years. Some bubble formulations are easy to manufacture. For example, many parents create bubble solutions by mixing dishwashing soap and water.

Water varies widely in its quality. Soft water is good for bubbles. Hard water, well water, and any water containing high levels of iron are bad for bubbles. To get the best mixture, it appears to be agreed upon that distilled water is the preferred water source.

The soap decreases the surface tension of the water. There are numerous varieties of soap that can be used. Some are conventional dishwashing soaps and others use the active ingredients in such dishwashing soaps. Such active agents include and are not limited to sodium lauryl sulfate, C₁₂H₂₅NaO₄S. This active agent is useful in a wide variety of personal care applications in which viscosity building and foam characteristics are of importance. It is compatible with alkanolamides and amphoterics so that maximum optimization of foam and viscosity characteristics can be reached in the finished product.

The parent then gives the solution to its child. To obtain the maximum result, the parent should delay giving the solution to the child for at least 12 hours. As expected, the child 8 dips, and many times spills the solution on the ground, an aperture 12 of a conventional bubble wand 10 into the solution. A film is then formed across the aperture 12. The child 8 then pushes a gas, normally its breadth, against one surface of the film. The film is then displaced from the apertured surface and produces a free-floating bubble 14. Each bubble 14 is normally a single bubble, as illustrated in FIG. 1.

From such bubbly foundations, the bubble industry has burst into specialty bubble formulations. In particular, Joseph Ehrlich, in U.S. Pat. No. 4,511,497, identifies that there are a great variety of bubble solution formations. These formulations have been suggested to feature special effects in bubble making.

In particular, Ehrlich discloses many “solutions for making large bubbles, long lasting bubbles, deep colored bubbles, split bubbles, self-healing bubbles, multiple bubbles, vanishing bubbles, bursting bubbles, high and/or far-flying bubbles, sinking bubbles,” and bead-forming bubbles (collectively referred to as “Special Effects”). See col. 1, lines 10-15.

Bead forming bubbles are disclosed as “long-floating bubbles which, when allowed to float at least for 15 to 20 (sic) second, will eventually settle down (sic) of the ground or cling to other solid objects without breaking. Such bubbles form transparent, completely spherical beads which cling to solid objects just with one single point of their surface and can stay there for many hours before collapsing to a jelly mass.” Col. 7, lines 12-19 of the '497 patent.

In any case, many of these formulations are found in U.S. Pat. No. 4,511,497. Many of Ehrlich's specialty bubble solutions use a soap—for example, sodium lauryl sulfate—, water, and a plasticizer—for example glycerin, Karo syrup and linseed oil. These plasticizers are recognized by bubble experts as having the ability to make a bubble more sturdy and colorful.

From these three fundamental specialty bubble ingredients—a soap, water and a plasticizer—, Ehrlich adds other ingredients to obtain the Special Effects. One of those other ingredients is an organic polymeric resin. Ehrlich discloses, at col. 2 lines 14-19, that acceptable organic polymeric resins for bubble solutions have a “typical molecular weight range from 60,000 to 1,000,000 . . . .” In other words, Ehrlich teaches that for a bubble solution to have the ability to form certain Special Effects, the solution should contain an organic polymeric resin having a molecular weight that should not significantly exceed 1 million.

In view of all this information, Applicant is unaware of any bubble formation that is designed to create a plurality of bubbles wherein each bubble is interconnected to another bubble. The present invention solves this problem.

### SUMMARY OF THE INVENTION

The present invention is directed to a product and a method of making that product. The product is a unique bubble making solution that when bubbles are formed each bubble is interconnected to another bubble by a string of bubble solution. Admittedly, a portion of the bubble solution is known to those of ordinary skill in the art. That known portion is referred to as the fundamental bubble solution and it comprises at least one surfactant, at least one plasticizer, and water. From that fundamental bubble solution, the inventors add an effective amount of an organic polymeric resin having a molecular weight greater than 3 million. With that high molecular weight polymer, each formed bubble is interconnected to another bubble.

### BRIEF DESCRIPTION OF THE DRAWINGS

FIG. 1 illustrates a child forming conventional bubbles.

FIG. 2 illustrates a child forming bubbles of the present invention.

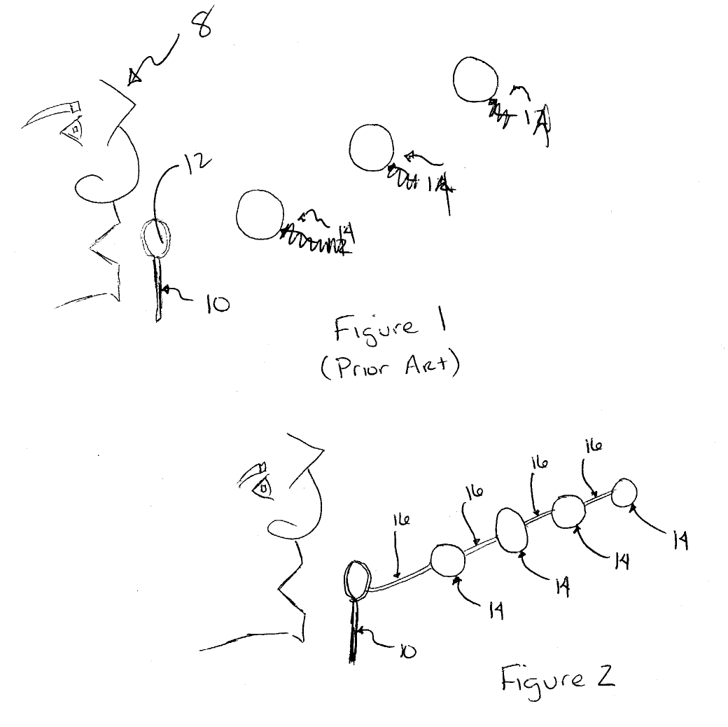

### DETAILED DESCRIPTION OF THE INVENTION

The present invention is directed to a unique bubble solution. This bubble solution is designed to form bubbles from a conventional bubble blowing apparatus—a bubble wand of any shape or material—wherein each bubble is interconnected to another bubble.

As with any specialized bubble solution, the bubble solution contains at least one soap, water and at least one plasticizer. As stated above, those three ingredients are the foundation for all specialized bubble solutions (“Foundation Solution”).

By adding an organic polymeric resin material having a molecular weight ranging from 3 million to 15 million to a Foundation Solution, the inventor determined that resulting bubbles will be interconnected, by a line of bubble material 16, to other bubbles, as illustrated in FIG. 2. Applicant is unaware of any bubble solution that creates the effect illustrated in FIG. 2.

In a preferred embodiment, the organic polymeric resin material having a molecular weight ranging from 3 million to 15 million has a molecular weight of around 7 million. In addition, the organic polymeric resin material can be any organic polymeric resin having an oxygen element therein. Such organic resin materials include and are not limited to polyethylene oxide, polypropylene oxide, and methoxy cellulose. To obtain a desired result, the organic polymeric resin material should be about 0.01 to 4% of the bubble solution. Preferably the percentage is about 0.1 to 1.2% and most preferred 0.8%, of the bubble solution.

### EXAMPLE 1

0.8% PEO having a molecular weight of about 7 million

3% a plasticizer—for example glycerin

7% a soap—for example 30% solution of sodium lauryl sulfate

3% a soap—bubble stabilizer—for example a 30% solution of Cocamidopropyl Betaine

Remainder is water and conventional preservatives.

### EXAMPLE 2

15% PEO having a molecular weight less than 1 million to form “snow flakes” once the bubbles burst

0.8% PEO having a molecular weight of about 7 million

3% a plasticizer—for example glycerin

7% a soap—for example 30% solution of sodium lauryl sulfate

3% a soap—bubble stabilizer—for example a 30% solution of Cocamidopropyl Betaine

Remainder is water and conventional preservatives.

The addition of an organic polymeric resin with a molecular weight greater than 3 million, and preferably ranging from 3 million to 15 million, to any conventional Special Effects Bubble Solution, as described by Ehrlich in U.S. Pat. No. 4,511,497, results in each bubble being interconnected to another bubble as illustrated in FIG. 2.

While the preferred embodiment of the invention has been illustrated and described, it will be clear that the invention is not so limited. Numerous modifications, changes, variations, substitutions and equivalents will occur to those skilled in the art without departing from the spirit and scope of the present invention as defined by the appended claims.

We claim:

1. A bubble solution having at least one surfactant, at least one plasticizer, and water to form a fundamental bubble solution, the bubble solution comprising:
an effective amount of an organic polymeric resin so that when bubbles are formed each bubble is interconnected to another bubble.

2. The fundamental bubble solution of claim 1 wherein the organic polymeric resin has a molecular weight greater than 3 million.

3. The fundamental bubble solution of claim 2 wherein the effective amount of the organic polymeric resin having a molecular weight greater than 3 million ranges from 0.01 to 4% of the fundamental bubble solution.

4. The fundamental bubble solution of claim 3 wherein the effective amount is from 0.1 to 1.2% of the fundamental bubble solution.

5. The fundamental bubble solution of claim 3 wherein the effective amount is about 0.8% of the fundamental bubble solution.

6. The fundamental bubble solution of claim 2 wherein the molecular weight of the organic polymeric resin is 3 million to 15 million.

7. The fundamental bubble solution of claim 6 wherein the molecular weight of the organic polymeric resin is about 7 million.

8. The fundamental bubble solution of claim 1 wherein the organic polymeric resin is any organic polymeric resin having an oxygen element therein.

9. The fundamental bubble solution of claim 8 wherein the organic polymeric resin having an oxygen element therein is selected from the group consisting of polyethylene oxide, polypropylene oxide, and methoxy cellulose.

10. The fundamental bubble solution of claim 1 wherein the interconnection of a bubble to another bubble is a string of bubble solution.

11. A method to form a bubble solution having at least one surfactant, at least one plasticizer, and water to form a fundamental bubble solution, the process comprising:
adding an effective amount of an organic polymeric resin having a molecular weight greater than 3 million into a fundamental bubble solution;
wherein when bubbles are formed each bubble is interconnected to another bubble.

11. The method claim 10 wherein the effective amount of the organic polymeric resin having a molecular weight greater than 3 million ranges from 0.01 to 4% of the fundamental bubble solution.

12. The method of claim 11 wherein the effective amount is from 0.1 to 1.2% of the fundamental bubble solution.

13. The method of claim 11 wherein the effective amount is about 0.8% of the fundamental bubble solution.

14. The method of claim 10 wherein the molecular weight of the organic polymeric resin is 3 million to 15 million.

15. The method of claim 14 wherein the molecular weight of the organic polymeric resin is about 7 million.

16. The method of claim 10 wherein the organic polymeric resin is any organic polymeric resin having an oxygen element therein.

17. The method of claim 16 wherein the organic polymeric resin having an oxygen element therein is selected from the group consisting of polyethylene oxide, polypropylene oxide, and methoxy cellulose.

18. The method of claim 10 wherein the interconnection of a bubble to another bubble is a string of bubble solution.

19. The fundamental bubble solution of claim 1 further comprising a polymeric resin material having a molecular weight less than 2 million so that when the bubbles burst a flake will result.

20. The method of claim 10 further comprising a polymeric resin material having a molecular weight less than 2 million so that when the bubbles burst a flake will result.
